(19) United States
(12) Patent Application Publication
(10) Pub. No.: US 2009/0225552 A1
(43) Pub. Date: Sep. 10, 2009

(54) Light source-modulating device having composite curved surfaces

(75) Inventor: Chi-Feng Chen, Taoyuan County (TW)

Correspondence Address: Juan Carlos A. Marquez;c/o Stites & Harbison PLLC, 1199 North Fairfax Street, Suite 900, Alexandria, VA, 22314-1437, US

(73) Assignee: National Central University

(21) Appl. No.: 12/073,759

(22) Filed: Mar. 10, 2008

(51) Int. Cl. F21V 5/00

(52) U.S. Cl. 362/333

(57) ABSTRACT

A light source-modulating device having composite curved surfaces comprises a light-distributing composite refractive surface, a base surface, a reflective surface and a light-modulating composite refractive surface, wherein the light-distributing composite refractive surface has a first and a second refractive surface, and the light-modulating composite refractive surface has a third and a fourth refractive surface. The light source-modulating device is particularly shaped so that light rays emitted from a light source and forming with a normal direction thereof an angle smaller than a light-distributing reference angle passes from the first refractive surface through the third refractive surface, which modulates an outgoing angle of said light rays; and light rays emitted from the light source and forming with the normal direction thereof an angle larger than the light-distributing reference angle passes from the second refractive surface to the reflective surface and is thereby reflected through the fourth refractive surface, which modulates an outgoing angle of said light rays. Thus, outgoing light rays emitted from the light source-modulating device are collimated and uniform.

### BACKGROUND OF THE INVENTION

1. Technical Field

The present invention relates to a light source-modulating device having composite curved surfaces and, more particularly, to a light source-modulating device used in lighting applications.

2. Description of Related Art

With continuous progress of light-emitting diode (LED) manufacturing techniques, radiation power and brightness of LEDs are gradually increased. Therefore, LEDs are having more and more applications, including, for example, general lighting or ambiance lighting. When LEDs are used for lighting purposes, light rays emitted therefrom have to be uniform and collimated, so that energy thereof is concentrated for practical use.

FIG. 1 is a cross-sectional view of a conventional LED lens structure 10 proposed in “Ultra Small Projector with High Efficiency Illumination System”, which was presented in the International Conference on Consumer Electronics (ICCE) held in January, 2006. This LED lens structure 10 comprises a spherical surface 11, a first non-spherical surface 12, a second non-spherical surface 13, a third non-spherical surface 14 and an LED light source 15. Light rays 16, 16′ and 16″ emitted from the LED light source 15 enter the LED lens structure 10 through the spherical surface 1 1. The light ray 16 which forms a relatively large angle with a normal direction of the LED light source 15 is reflected by the third non-spherical surface 14 and then refracted outwards by the second non-spherical surface 13 so as to be nearly collimated. On the other hand, the light ray 16′ which forms a relatively small angle with the normal direction of the LED light source 15 is refracted outwards by the first non-spherical surface 12.

FIGS. 2 and 3 illustrate a light pattern and an illuminance distribution of the conventional LED lens structure 10, respectively. As shown in FIGS. 2 and 3, while the conventional LED lens structure 10 is capable of collimating the light rays 16, 16′ and 16″ emitted from the LED light source 15, a large included angle is formed between the first non-spherical surface 12 and the second non-spherical surface 13, i.e., the second non-spherical surface 13 is an inclined surface having a large angle of inclination. As a result, some of the light rays incident on the first non-spherical surface 12, such as the light ray 16″, cannot be refracted out of the lens structure 10 because the condition of having an incident angle smaller than a critical angle is not satisfied. Hence, illuminance is not uniform between the first non-spherical surface 12 and the second non-spherical surface 13, while the LED light source 15 produces a light pattern comprising a number of concentric circles, thereby lowering a uniformity of outgoing light.

### SUMMARY OF THE INVENTION

The present invention is directed to a light source-modulating device having composite curved surfaces wherein a shape of the light source-modulating device is particularly designed. Therein, a light-distributing composite refractive surface is designed to allow light rays emitted from a light source and forming with a normal direction thereof angles smaller or larger than a light-distributing reference angle to enter the device through a first refractive surface and a second refractive surface, respectively. Further, a reflective surface is designed to reflect incident light rays from the second refractive surface so that the reflected light rays are refracted outwards by a third refractive surface. The third refractive surface, in turn, is designed to refract outwards all incident light rays from the second refractive surface while modulating outgoing angles of such light rays. Moreover, a fourth refractive surface is designed to refract outwards all incident light rays from the first refractive surface while modulating outgoing angles of such light rays. Thus, outgoing light rays from the LED light source will be collimated and uniform and have reduced divergence angles.

To achieve this end, the present invention provides a light source-modulating device having composite curved surfaces, comprising a light-distributing composite refractive surface, a base surface, a reflective surface and a light-modulating composite refractive surface. The light-distributing composite refractive surface has a first refractive surface which is a curved surface defined by a function and has a central surficial axis coexisting with a central axis of the light source-modulating device, wherein the first refractive surface is located to refract light rays emitted from at least one LED light source and forming with a normal direction of the LED light source an angle smaller than a light-distributing reference angle; and a second refractive surface which is a curved surface symmetric with respect to the central axis and has a first periphery connected with a periphery of the first refractive surface to form an accommodating space, wherein the second refractive surface is located to refract light rays emitted from the LED light source and forming with the normal direction of the LED light source an angle larger than the light-distributing reference angle. The base surface has a first periphery connected with a second periphery of the second refractive surface to form a first joint line. The reflective surface is a curved surface symmetric with respect to the central axis and has a first periphery connected with a second periphery of the base surface to form a second joint line, wherein the reflective surface is located to reflect incident light rays from the light-distributing composite refractive surface. The light-modulating composite refractive surface has a third refractive surface which is a curved surface defined by a function and symmetric with respect to the central axis and has a first periphery connected with a second periphery of the reflective surface to form a third joint line, wherein the third refractive surface is located to modulate incident light rays from the reflective surface; and a fourth refractive surface which is a curved surface symmetric with respect to the central axis and has a periphery connected with a second periphery of the third refractive surface to form a fourth joint line, wherein the fourth refractive surface is located to modulate incident light rays from the first refractive surface. Therein, the light-distributing reference angle is within ±10° of a light-distributing critical angle, which is defined as an included angle between a critical light ray before entering the light source-modulating device and the normal direction of the LED light source, wherein the critical light ray is defined as a light ray emitted from the LED light source that enters the light source-modulating device through a joint line connecting the periphery of the first refractive surface with the first periphery of the second refractive surface and then leaves the light source-modulating device through the fourth joint line.

Implementation of the present invention at least produces the following advantageous effects:

1. Outgoing light rays emitted from the LED light source can be collimated and uniform; and

2. A divergence angle of the LED light source can be reduced by changing a shape of the light-modulating composite refractive surface.

Features and advantages of the present invention will be described below in detail so that the technical content of the present invention can be understood and carried out by those skilled in the art, while objectives and advantages of the present invention can be readily comprehended by reference to the content, claims and drawings disclosed herein.

### BRIEF DESCRIPTION OF THE DRAWINGS

The present invention as well as a preferred mode of use, further objectives and advantages thereof will best be understood by reference to the following detailed description of an illustrative embodiment when read in conjunction with the accompanying drawings, wherein:

FIG. 1 is a cross-sectional view of a conventional LED lens structure;

FIG. 2 illustrates a light pattern of the conventional LED lens structure;

FIG. 3 is a plot showing an illuminance distribution of the conventional LED lens structure;

FIG. 4 is a perspective view of a light source-modulating device having composite curved surfaces according to the present invention;

FIG. 5 is a first cross-sectional view of the light source-modulating device having composite curved surfaces according to the present invention;

FIG. 6 is a second cross-sectional view of the light source-modulating device having composite curved surfaces according to the present invention;

FIG. 7 is a third cross-sectional view of the light source-modulating device having composite curved surfaces according to the present invention;

FIG. 8 is a fourth cross-sectional view of the light source-modulating device having composite curved surfaces according to the present invention;

FIG. 9 is a fifth cross-sectional view of the light source-modulating device having composite curved surfaces according to the present invention;

FIG. 10 is a sixth cross-sectional view of the light source-modulating device having composite curved surfaces according to the present invention;

FIG. 11 is a light pattern of the light source-modulating device having composite curved surfaces shown in FIG. 7; and

FIG. 12 is a plot showing an illuminance distribution of the light source-modulating device having composite curved surfaces shown in FIG. 7.

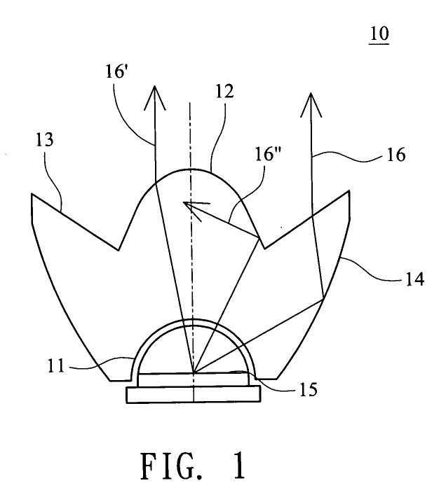

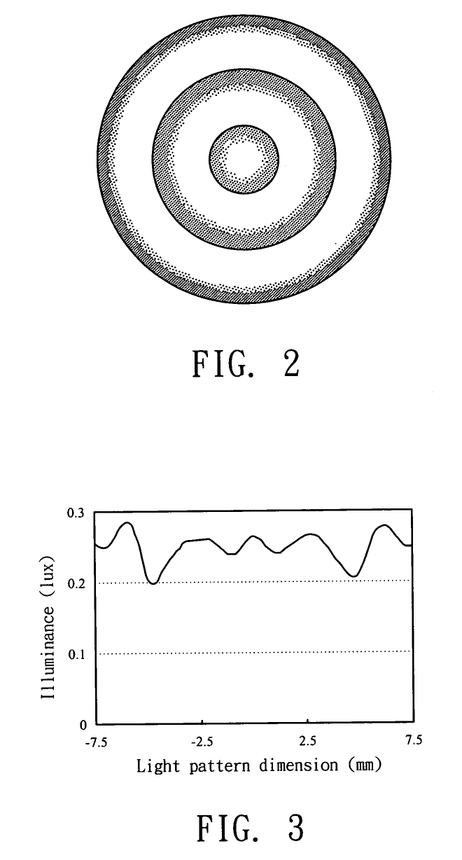

### DETAILED DESCRIPTION OF THE PREFERRED EMBODIMENT

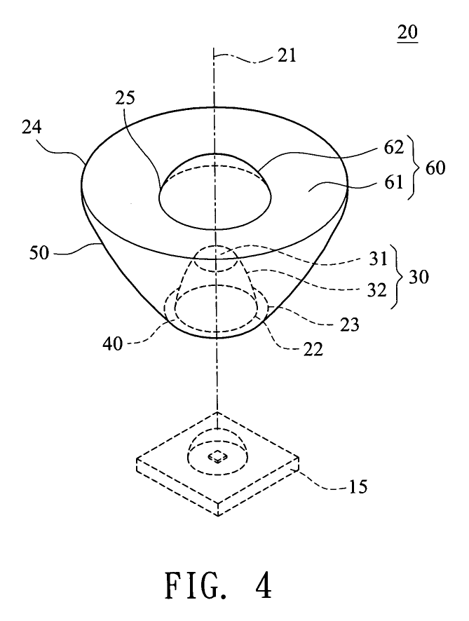

Referring to FIG. 4, a light source-modulating device 20 having composite curved surfaces comprises a light-distributing composite refractive surface 30, a base surface 40, a reflective surface 50 and a light-modulating composite refractive surface 60. The light source-modulating device 20 has a central axis 21 and is of a circularly or elliptically symmetric structure with respect to the central axis 21. Further, the light source-modulating device 20 can be made of a plastic material by injection molding.

The light-distribution composite refractive surface 30 has a first refractive surface 31 and a second refractive surface 32. The light-distributing composite refractive surface 30 serves to distribute light rays emitted from an LED light source 15, so that the light rays enter the light source-modulating device 20 through the first refractive surface 31 and the second refractive surface 32, respectively.

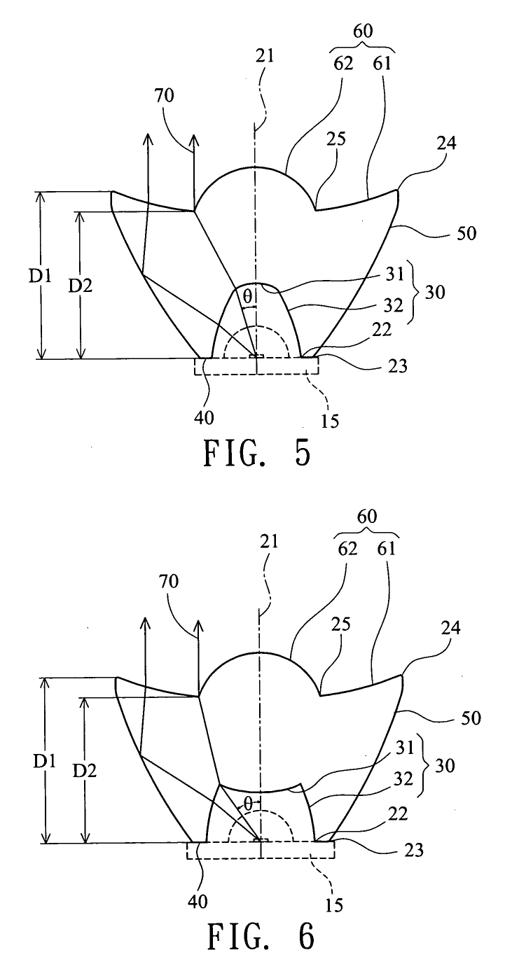

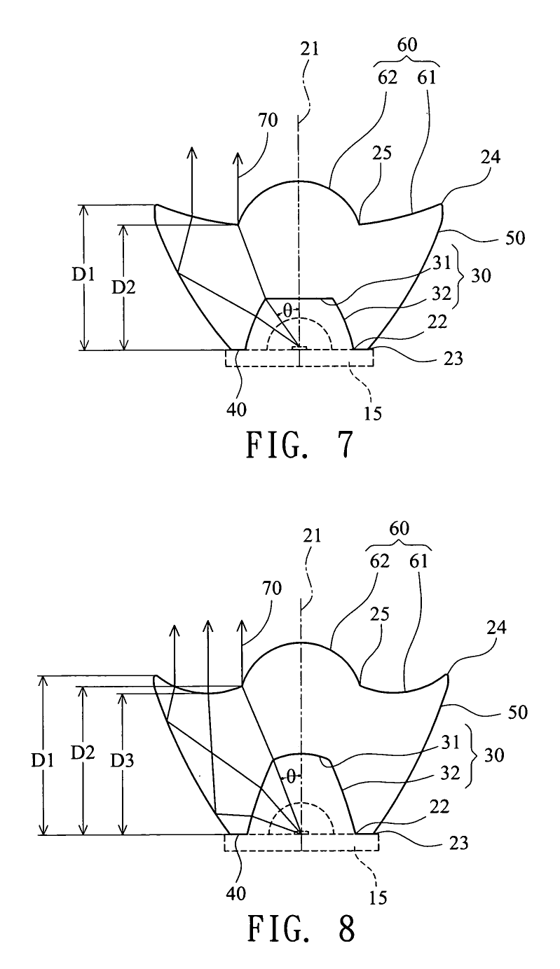

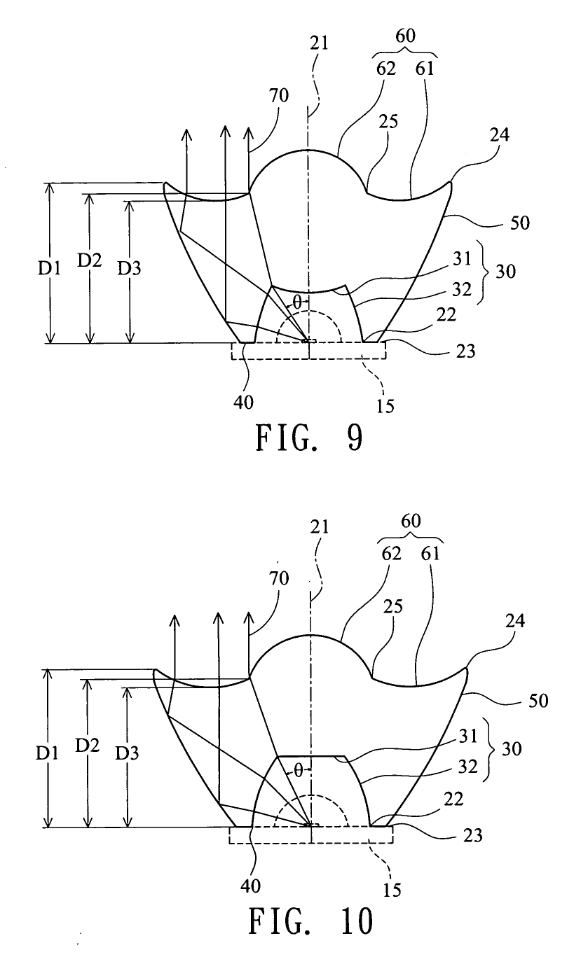

The first refractive surface 31 is a curved surface defined by a function and can be designed as needed as different curved surfaces defined by corresponding functions. For instance, the first refractive surface 31 can be a surface defined by a concave function (as shown in FIGS. 5 and 8), a convex function (as shown in FIGS. 6 and 9) or a plane function (as shown in FIGS. 7 and 10). Furthermore, the first refractive surface 31 has a central surficial axis coexisting with the central axis 21 of the light source-modulating device 20. The first refractive surface 31 is located to refract light rays emitted from the at least one LED light source 15 and forming with a normal direction of the LED light source 15 an angle smaller than a light-distributing reference angle θ, which is defined in the following paragraphs.

As shown in FIG. 5, the light source-modulating device 20 is particularly designed so that a light ray emitted from the LED light source 15 and entering the light source-modulating device 20 through a joint line connecting a periphery of the first refractive surface 31 and a first periphery of the second refractive surface 32 leaves the light source-modulating device 20 through a fourth joint line 25 (defined further below). This particular light ray is defined as a critical light ray 70, and a light-distributing critical angle is an included angle between the critical light ray 70 before entering the light source-modulating device 20 and the normal direction of the LED light source 15. The light-distributing critical angle may range from 15° to 75°.

The light-distributing reference angle θ is within ±10° of the light-distributing critical angle. For example, if the light-distributing critical angle is 15°, the light-distributing reference angle may range from 5° to 25°. Preferably, the light-distributing reference angle θ is equal to the light-distributing critical angle. If a light ray emitted from the LED light source 15 forms with the normal direction thereof an angle smaller than the light-distributing reference angle θ, then the light ray will be distributed to the first refractive surface 31, which refracts the light ray into the light source-modulating device 20.

Referring to FIG. 4 and FIGS. 5 to 10, the second refractive surface 32 is an arbitrary curved surface symmetric with respect to the central axis 21. The first periphery of the second refractive surface 32 is connected with the periphery of the first refractive surface 31 to form an accommodating space for accommodating the LED light source 15. The LED light source 15 can be an LED chip or a packaged LED and has a light-emitting wavelength ranging from 350 nm to 850 nm.

The second refractive surface 32 is located to refract light rays emitted from the LED light source 15 and forming with the normal direction thereof an angle larger than the light-distributing reference angle θ. In other words, all light rays emitted from the LED light source 15 forming with the normal direction thereof angles larger than the light-distributing reference angle θ will be distributed to the second refractive surface 32, which refracts the light rays into the light source-modulating device 20.

The base surface 40 has a first periphery connected with a second periphery of the second refractive surface 32 to form a first joint line 22, and a second periphery connected with a first periphery of the reflective surface 50 to form a second joint line 23. The base surface 40 is provided with a positioning structure for retaining the LED light source 15 in place inside the accommodating space formed by the first refractive surface 31 and the second refractive surface 32, so that a geometric center of the LED light source 15 is located on an extension line of the central axis 21 of the light source-modulating device 20, allowing light rays emitted from the LED light source 15 to enter the light source-modulating device 20 uniformly.

The reflective surface 50 is an arbitrary curved surface symmetric with respect to the central axis 21 and has the first periphery connected with the second periphery of the base surface 40 to form the second joint line 23. Moreover, the reflective surface 50 is located to reflect incident light rays from the light-distributing composite refractive surface 30, wherein a shape of the reflective surface 50 can be so designed that all light rays incident thereon are totally reflected to a third refractive surface 61. In this case, the shape of the reflective surface 50 must satisfy a condition that all light rays incident thereon have incident angles larger than a critical angle, so that the light rays are totally reflected by the reflective surface 50, thereby changing travel directions of the light rays.

The light-modulating composite refractive surface 60 has the third refractive surface 61 and a fourth refractive surface 62. The light-modulating composite refractive surface 60 serves to modulate light rays reflected by the reflective surface 50 and light rays refracted by the first refractive surface 31. Outgoing paths of the light rays can be modulated by properly designing the light-modulating composite refractive surface 60, so that light rays emitted from the LED light source 15 are collimated and uniform.

The third refractive surface 61 is an arbitrary curved surface defined by a function and symmetric with respect to the central axis 21. The third refractive surface 61 has a first periphery connected with a second periphery of the reflective surface 50 to form a third joint line 24, and is located to modulate light rays reflected by the reflective surface 50. Moreover, the third refractive surface 61 has a shape allowing light rays incident thereon to have incident angles smaller than the critical angle, so that the light rays are refracted out of the light source-modulating device 20 nearly parallel to the central axis 21. In other words, outgoing light rays from the third refractive surface 61 have very small divergence angles and are considerably collimated.

The fourth refractive surface 62 is an arbitrary curved surface, such as a convex surface, symmetric with respect to the central axis 21 and has a periphery connected with a second periphery of the third refractive surface 61 to form the fourth joint line 25. In addition, the fourth refractive surface 62 is located to modulate incident light rays from first refractive surface 31. A shape of the fourth refractive surface 62 can be designed to allow light rays incident thereon to have incident angles smaller than the critical angle, so that the light rays which have been refracted by the first refractive surface 31 are refracted once again, and the light rays refracted out of the light source-modulating device 20 are nearly parallel to the central axis 21. In other words, outgoing light rays emitted from the light source-modulating device 20 are considerably collimated.

In order to fine-tune a collimation and uniformity of outgoing light rays emitted from the light source-modulating device 20 of the embodiment of the present invention, the shape of the third refractive surface 61 can be further designed. As shown in FIGS. 5, 6 and 7, a first distance D1 can be designed to be greater than a second distance D2 (D1>D2), wherein the first distance D1 is a vertical distance between the third joint line 24 and the base surface 40, and the second distance D2 is a vertical distance between the fourth joint line 25 and the base surface 40. Or alternatively, as shown in FIGS. 8, 9 and 10, the first distance D1 and the second distance D2 can be both designed to be greater than a third distance D3 (D1>D3 and D2>D3), wherein the third distance D3 is a vertical distance between a lowest point of the third refractive surface 61 and the base surface 40.

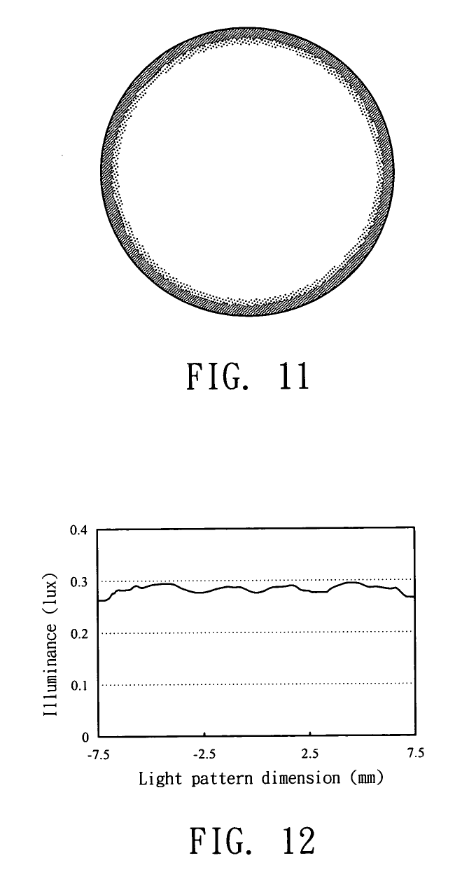

Take for example the light source-modulating device 20 having composite curved surfaces in FIG. 7, wherein the light source-modulating device 20 is of a circularly symmetric structure. An optical simulation software ASAP (Advanced System Analysis Program) from the Breault Research Organization in the United States was used to simulate a light pattern and an illuminance distribution of the light source-modulating device 20 having composite curved surfaces in FIG. 7 on a plane approximately 18 mm from the LED light source 15, as shown in FIGS. 11 and 12, respectively. The light pattern has an effective, uniform range with a diameter of approximately 15 mm while the illuminance is uniformly distributed. In addition, there are no more concentric circles in the light pattern. In other words, outgoing light rays emitted from the light source-modulating device 20 having composite curved surfaces are considerably collimated and have a very uniformly distributed illuminance.

The light source-modulating device 20 having composite curved surfaces according to the embodiment of the present invention serves to collimate light rays emitted from the LED light source 15 and provide the light rays with a uniform illuminance. Therefore, it is advised to first analyze an LED light source 15 to be modulated, and then plan and design the light-distributing composite refractive surface 30, the reflective surface 50 and the light-modulating composite refractive surface 60 of the light source-modulating device 20 according to a desired distance and range of illumination, so as to achieve such illumination distance and range.

It should be noted that the embodiments of the present invention as described above are intended to demonstrate features of the present invention, so that a person skilled in the art can understand the content disclosed herein and carry out the present invention accordingly. However, these embodiments are not intended to limit the scope of the present invention. Therefore, all equivalent modifications and alterations should be encompassed by the appended claims provided such modifications and alterations do not depart from the spirit of the present invention.

What is claimed is:

1. A light source-modulating device having composite curved surfaces, comprising:
a light-distributing composite refractive surface, having:
a first refractive surface, which is a curved surface defined by a function and has a central surficial axis coexisting with a central axis of the light source-modulating device, wherein the first refractive surface is located to refract light rays emitted from at least one light-emitting diode (LED) light source and forming with a normal direction of the LED light source an angle smaller than a light-distributing reference angle; and
a second refractive surface, which is a curved surface symmetric with respect to the central axis and has a first periphery connected with a periphery of the first refractive surface to form an accommodating space, wherein the second refractive surface is located to refract light rays emitted from the LED light source and forming with the normal direction of the LED light source an angle larger than the light-distributing reference angle;
a base surface, having a first periphery connected with a second periphery of the second refractive surface to form a first joint line;
a reflective surface, which is a curved surface symmetric with respect to the central axis and has a first periphery connected with a second periphery of the base surface to form a second joint line, wherein the reflective surface is located to reflect incident light rays from the light-distributing composite refractive surface; and
a light-modulating composite refractive surface, having:
a third refractive surface, which is a curved surface defined by a function and symmetric with respect to the central axis and has a first periphery connected with a second periphery of the reflective surface to form a third joint line, wherein the third refractive surface is located to modulate incident light rays from the reflective surface; and
a fourth refractive surface, which is a curved surface symmetric with respect to the central axis and has a periphery connected with a second periphery of the third refractive surface to form a fourth joint line, wherein the fourth refractive surface is located to modulate incident light rays from the first refractive surface;
wherein the light-distributing reference angle is within ±10° of a light-distributing critical angle, which is defined as an included angle between a critical light ray before entering the light source-modulating device and the normal direction of the LED light source, in which the critical light ray is defined as a light ray emitted from the LED light source that enters the light source-modulating device through a joint line connecting the periphery of the first refractive surface with the first periphery of the second refractive surface and then leaves the light source-modulating device through the fourth joint line.

2. The light source-modulating device as claimed in claim 1, which is of a circularly symmetric structure.

3. The light source-modulating device as claimed in claim 1, which is of an elliptically symmetric structure.

4. The light source-modulating device as claimed in claim 1, which is made of a plastic material.

5. The light source-modulating device as claimed in claim 1, wherein the first refractive surface is a plane, a curved surface defined by a concave function or a curved surface defined by a convex function.

6. The light source-modulating device as claimed in claim 1, wherein the light-distributing critical angle is between 15° and 75°.

7. The light source-modulating device as claimed in claim 1, wherein the second refractive surface is an arbitrary curved surface.

8. The light source-modulating device as claimed in claim 1, wherein the first refractive surface is an arbitrary curved surface.

9. The light source-modulating device as claimed in claim 1, wherein the third refractive surface is an arbitrary curved surface defined by a function.

10. The light source-modulating device as claimed in claim 1, wherein the fourth refractive surface is an arbitrary curved surface.

11. The light source-modulating device as claimed in claim 1, wherein a vertical distance between the third joint line and the base surface is greater than a vertical distance between the fourth joint line and the base surface.

12. The light source-modulating device as claimed in claim 1, wherein the vertical distance between the third joint line and the base surface and the vertical distance between the fourth joint line and the base surface are both greater than a vertical distance between a lowest point of the third refractive surface and the base surface.

13. The light source-modulating device as claimed in claim 1, wherein the base surface is provided with a positioning structure.

14. The light source-modulating device as claimed in claim 1, wherein the LED light source is located in the accommodating space while a geometric center of the LED light source is located on an extension line of the central axis.

15. The light source-modulating device as claimed in claim 1, wherein the LED light source is an LED chip or a packaged LED.

16. The light source-modulating device as claimed in claim 1, wherein the LED light source has a light-emitting wavelength ranging from 350 nm to 850 nm.
